(19) United States
(12) Patent Application Publication
(10) Pub. No.: US 2024/0008683 A1
(43) Pub. Date: Jan. 11, 2024

(54) Grilling Apparatus

(71) Applicant: Quizzit, Inc., Southold, NY (US)

(72) Inventor: Daniel A. DeVito, Southold, NY (US)

(21) Appl. No.: 17/811,598

(22) Filed: Jul. 11, 2022

(51) Int. Cl. A47J 37/08; A47J 37/07

(52) U.S. Cl. CPC A47J 37/0871; A47J 37/0704

(57) ABSTRACT

A removable device is provided to prevent food from touching the back wall of a grill during cooking. The device comprises a bottom panel which rests atop the grates of a grill, and a rear panel which provides a clean surface for food items to contact. From the perspective of a food item being grilled, the rear panel effectively replaces the back wall of the grill when the food item is pushed towards the back of the grill. The device thus can eliminate a food item touching the back wall of the grill.

### BACKGROUND

Often times, when people are grilling food items, such as a hamburger, hot dog, ribs, sausage, fish, chicken, vegetables and other items on a grill and attempt to turn the item over or flip them, the item does not fully rest on the utensil being used to turn it, such as a spatula. In such instances, the item usually is pushed to the rear of the grill where it engages the back wall of the grill allowing the user to maneuver the spatula fully under the item and move it back to its original grilling site. The problem arises because the food item touches the actual back wall of the grill which is often dirty from debris deposited on the back wall from prior use and because the user generally will clean the grill grates but not the back wall of the grill, thereby imparting harmful carbon deposits, pre-cooked, decayed and perhaps infected material to the product currently being cooked. The larger the item, the more contact with the compromised back wall. And, in reverse, when the item touches the back wall it can release particles of food that further contribute to a buildup of food on the back wall, and particles of food may also fall into the grill causing more unwanted debris. Depending on the design of the grill, if there is a gap between the back wall of the grill and the end of the grate, the item or a portion of it may fall into the gap and be lost. Thus, there exists a need for a device that rests on the grill grates at the back of the grilling surface.

### SUMMARY

A device comprises a bottom panel and a rear panel. In use, the bottom panel rests atop the grates of a grill, and the rear panel provides a surface to prevent food from touching the back wall of the grill. From the perspective of a food item being grilled, the rear panel effectively replaces the back wall of the grill when the food item is pushed towards the back of the grill. The device thus can eliminate a food item touching the back wall of the grill by way of the rear panel. Further, the bottom panel enables a user to reduce or eliminate the deposit of detached food particles from clogging and soiling the grill. The device also allows a user to reduce or eliminate flare-ups that occur as a food item is exposed to an open flame from the grill. Optional features include a rear engagement flap, one or more holes, attachment mechanisms, a tapered or beveled leading edge, one or two side walls, and adjustable length and height.

### BRIEF DESCRIPTION OF THE DRAWINGS

The detailed description makes reference to the accompanying figures wherein:

FIG. 1A illustrates a front view of an embodiment of a device in accordance with the principles disclosed herein.

FIG. 1B illustrates a rear view of the embodiment shown in FIG. 1A.

FIG. 1C illustrates a side perspective view of the embodiment shown in FIGS. 1A and 1B.

FIG. 2 illustrates an embodiment of a device comprising a left side wall, a right side wall, and protrusions from a bottom panel.

FIG. 3 illustrates an embodiment of a device comprising a plurality of holes.

FIG. 4A illustrates an embodiment of a device comprising a rear panel coupled to a bottom panel via a hinge.

FIG. 4B illustrates an embodiment of a device comprising a left side panel 44A coupled to a bottom panel via hinge.

FIG. 5 illustrates an embodiment of a device comprising a bottom panel coupled to a rear panel via hinged connections.

The figures are only intended to facilitate the description of the principles disclosed herein. The figures do not illustrate every aspect of the principles disclosed herein and do not limit the scope of the principles disclosed herein. Other objects, features, and characteristics will become more apparent upon consideration of the following detailed description.

### DETAILED DESCRIPTION

A detailed illustration is disclosed herein. However, techniques, methods, processes, systems and operating structures in accordance with the principles disclosed herein may be embodied in a wide variety of forms and modes, some of which may be quite different from those disclosed herein. Consequently, the specific structural and functional details disclosed herein are merely representative.

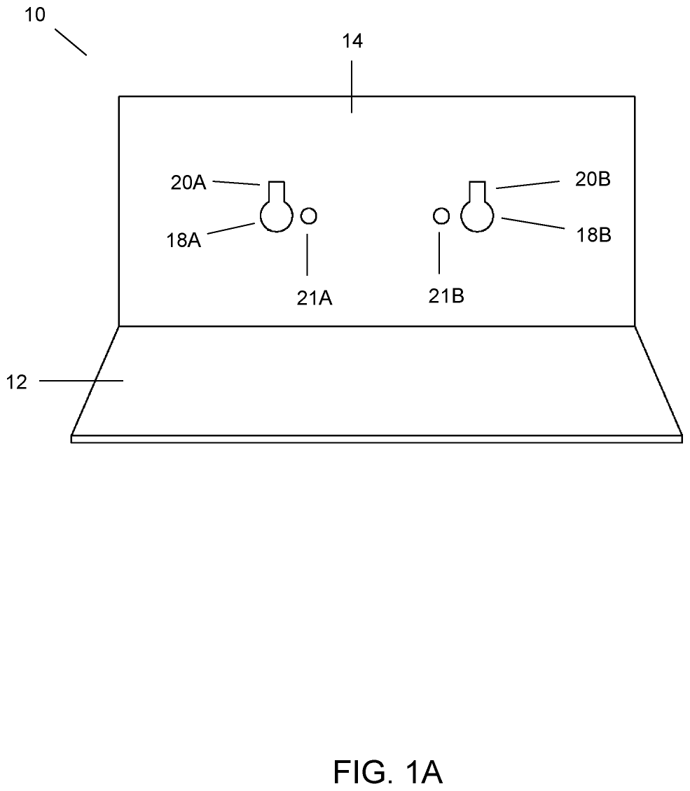

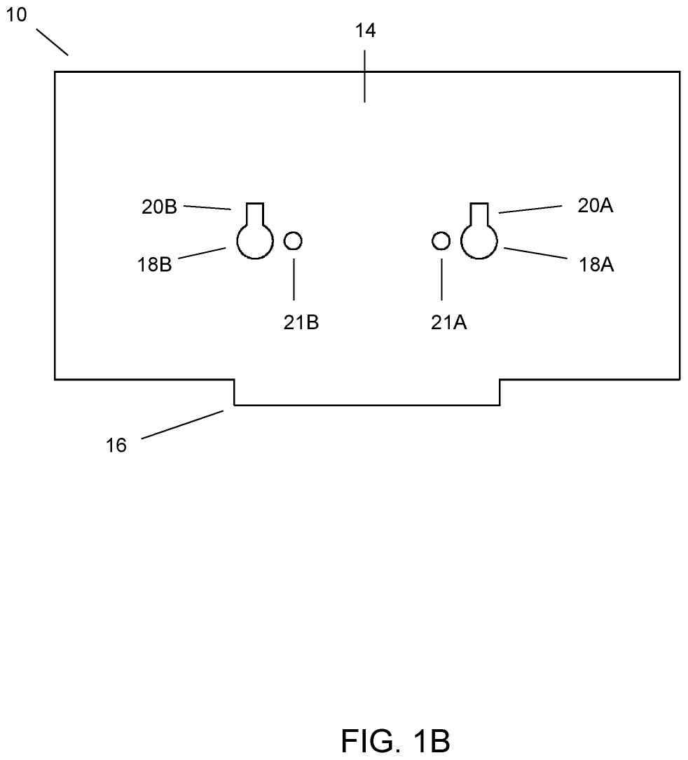

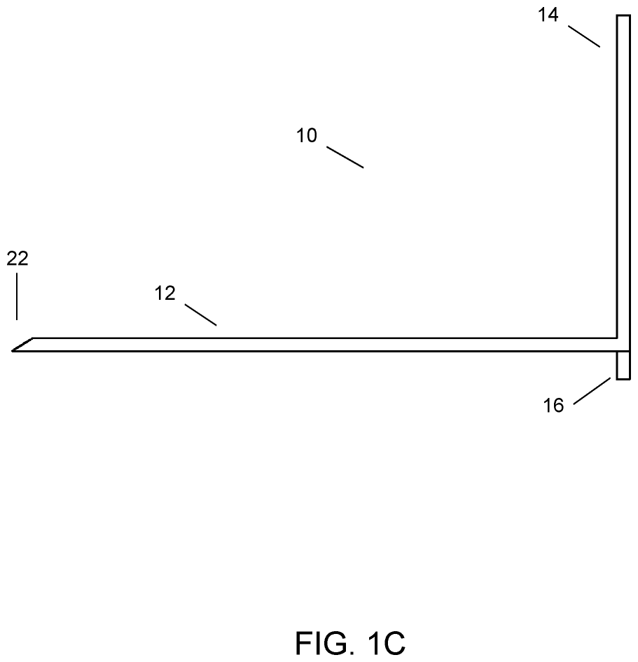

With reference to FIGS. 1A and 1B, shown is a device 10 comprising a bottom panel 12 and a rear panel 14. In use, bottom panel 12 rests atop the grates of a grill, and rear panel 14 provides a surface to prevent food from touching the back wall of the grill. From the perspective of a food item being grilled, rear panel 14 effectively replaces the back wall of the grill when the food item is pushed towards the back of the grill. The device 10 thus can eliminate a food item touching the back wall of the grill by way of the rear panel 14. Further, bottom panel 12 enables a user to reduce or eliminate the deposit of detached food particles from clogging and soiling the grill. The device also allows a user to reduce or eliminate flare-ups that occur as a food item is exposed to an open flame from the grill.

Optional rear engagement flap 16 extends downward from rear panel 14 and is configured to extend behind the grates of a grill, between the grates and the back wall of the grill. Rear engagement flap 16 at least partially secures the device 10 to the grill, limiting or eliminating forward-backward movement of device 10 with respect to the grill grates. Rear engagement flap 16 can be foldable to facilitate storage or other considerations. Rear engagement flap 16 is optional and may be included or omitted without regard to the other optional features disclosed herein. In some embodiments, rear engagement flap 16 is foldable or retractable and may be used when the grill design permits.

Optional first mounting hole 18A and optional second mounting hole 18B are disposed in rear panel 14 and allow device 10 to be secured to the back wall of a grill. Each of first mounting hole 18A and second mounting hole 18B are dimensioned and placed to receive, for example, a threaded screw coupled to the rear wall of the grill. A locking device may be used with a threaded screw, such as a wing nut or other removable locking mechanism, to facilitate removal of the device 10 for cleaning at the user's discretion. First mounting hole 18A and second mounting hole 18B may be placed onto protrusions secured to the back wall of the grill, thereby securing device 10 in place. Screws, bolts, or other suitable hardware may be fed through first mounting hole 18A and second mounting hole 18B and secured to the back wall of the grill to secure device 10 to the back wall of the grill. Optional top cutout 20A and optional top cutout 20B allow first mounting hole 18A and second mounting hole 18B to be placed onto protrusions on the back wall of the grill and then lowered, so that the protrusions fit into the narrower spaces of top cutout 20A and top cutout 20B, respectively, securing device 10 in place with respect to the back wall of the grill. For example, top cutout 20A and first mounting hole 18A can be shaped to form a teardrop or similar design configured to engage with a button-like protrusion coupled to the back wall of the grill. Optional screw holes 21A and 21B enable a user to screw or similarly fasten device 10 to the back wall of a grill. Each of first mounting hole 18A, second mounting hole 18B, top cutout 20A, top cutout 20B, screw hole 21A, and screw hole 21B is optional and may be included or omitted without regard to the other optional features disclosed herein. For example, an embodiment may include a single hole, with or without a top cutout, or three or more holes, with or without top cutouts, without departing from the principles disclosed herein. One or more other suitable attachment mechanisms, such as clip(s) and/or magnet(s), may optionally be used to temporarily or semi-permanently secure a device to the grill such that it could be removed after use for cleaning. In some embodiments, one or more suitable attachment mechanisms may be used to permanently secure a device to the grill if removal for cleaning or other purposes is not desired.

With reference to FIG. 1C, shown is an optional tapered or beveled leading edge 22 of bottom panel 12. The angle permits food and utensils to more easily slide from the surface of the grill grates onto the surface of bottom panel 12.

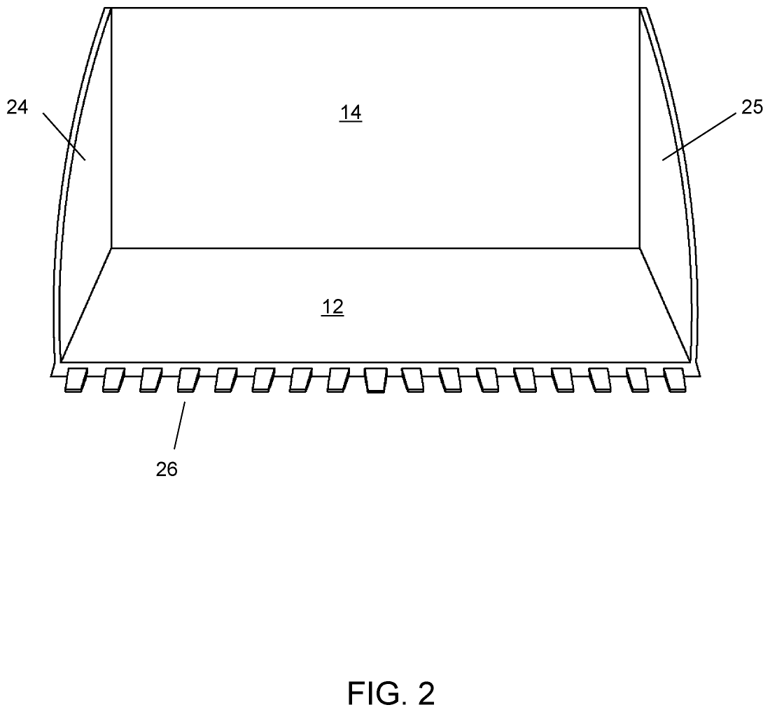

With reference to FIG. 2, shown are optional left side wall 24 and optional right side wall 25, each of which extends and connects to the bottom panel 12 and/or rear panel 14. Each of left side wall 24 and right side wall 25 may be dimensioned vertically at their rear edge to match the height of rear panel 14. Each of left side wall 24 and right side wall 25 may extend horizontally towards the front of the grill to match the length of the bottom panel 12. They can also be dimensioned to extend in that direction for only a portion of the length of bottom panel 12. Each of left side wall 24 and right side wall 25 can be shaped in various forms such as rectangular, or curved from the rear panel 14 downward toward the bottom panel 12. Each of left side wall 24 and optional right side wall 25 is optional and may be included or omitted without regard to the other optional features disclosed herein.

With reference to FIG. 2, shown are optional protrusions 26 extending from the leading edge of bottom panel 12. Protrusions 26 assist with sliding food from the surface of the grill grates onto the surface of bottom panel 12, particularly if any of the food is dipping down between the grill grates.

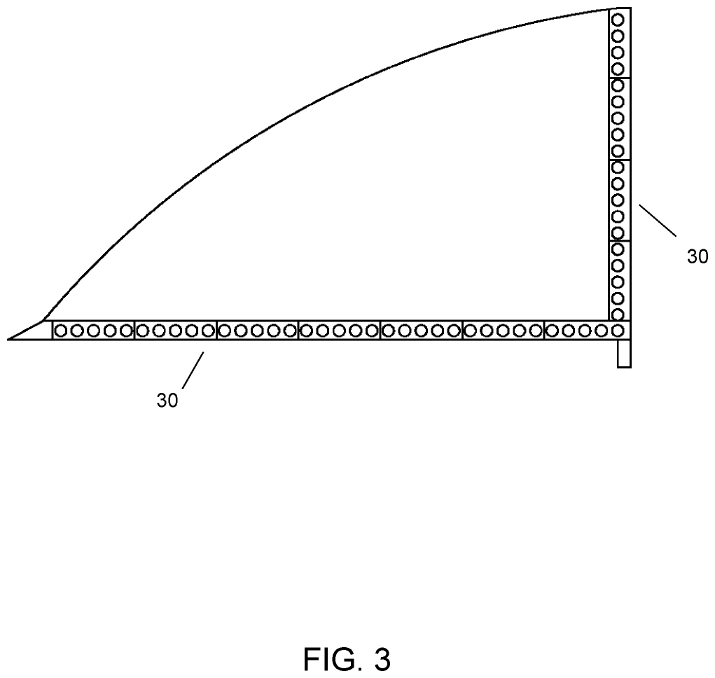

FIG. 3 depicts an embodiment with a plurality of holes 28, which may be used to secure the device to a grill or to provide a drain for liquids or semisolids. In some embodiments, these holes may be omitted entirely, or may be disposed on one or more panels or surfaces of the device.

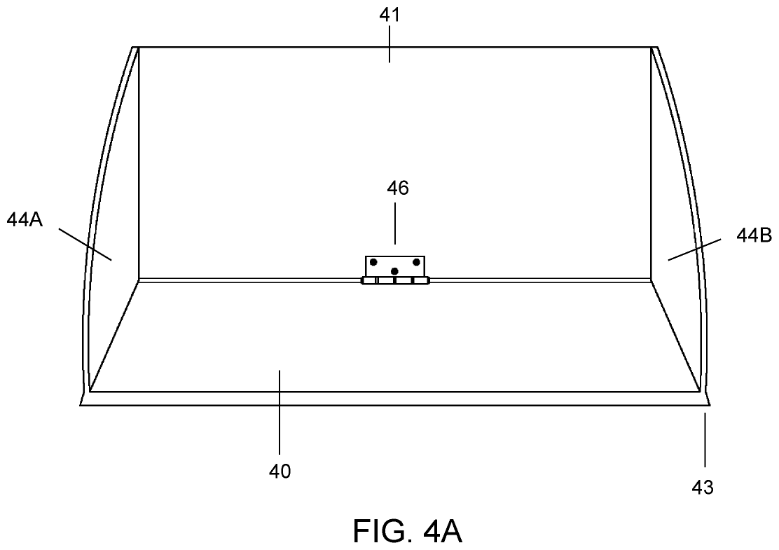

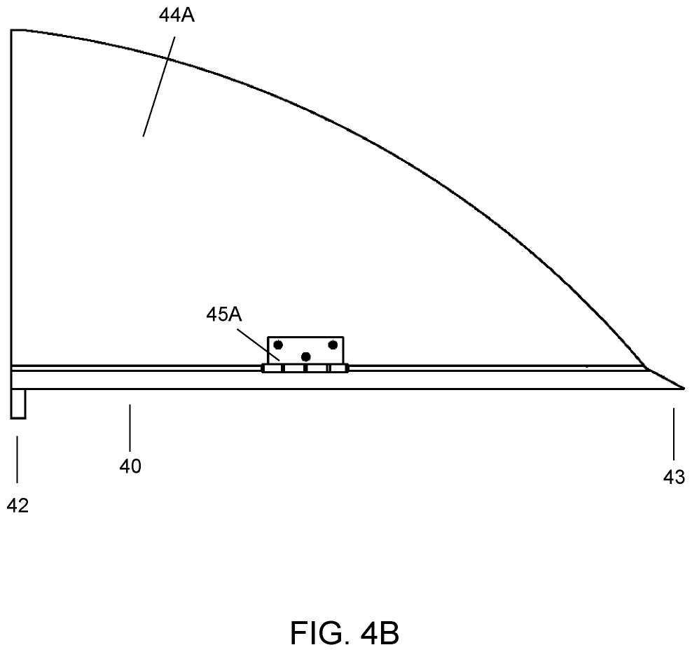

In a collapsible embodiment shown in FIGS. 4A and 4B, each of left side wall 44A and right side wall 44B are coupled to bottom panel 40 and either uncoupled from rear panel 41 or releasably coupled to rear panel 41. With reference to FIG. 4A, rear panel 41 is coupled to bottom panel 40 via hinge 46.

With reference to FIG. 4B, left side panel 44A is coupled to bottom panel 40 via hinge 45A, which allows left side panel 44A to move relative to rear panel 41 and, for example, collapse down toward bottom panel 40. In some embodiments, hinge 45A may be substantially stable so that it can hold left side panel 44A in a vertical position without further support from rear panel 41. In some embodiments, when left side panel 44A is in a vertical position, it can releasably engage with rear panel 41 via a friction fit or other suitable means. Although not shown, the foregoing principles disclosed with respect to left side panel 44A may also be applied to right side panel 44B. Also shown in FIG. 4B are rear engagement flap 42 and beveled edge 43.

In varying embodiments, the hinges 45A and 46, and any corresponding hinge coupled to right side panel 44B, can be a simple hinge or other mechanism(s) such as a strip of heat resistant polymer, carbon based material, or a flexible thin metal strip, such as aluminum, that would allow a panel to fold with respect to at least one other panel. Other similar methods and materials well known in the art may be used to enable left side panel 44A and/or right side panel 44B to move relative to bottom panel 40. In some embodiments, the device is configured so that when the rear panel 41 is urged downwardly from its vertical position to a horizontal position, the left side panel 44A and right side panel 44B will collapse inwardly and rest underneath the rear panel 41 in its horizontal position. This facilitates storage and cleaning, particularly in a dishwasher.

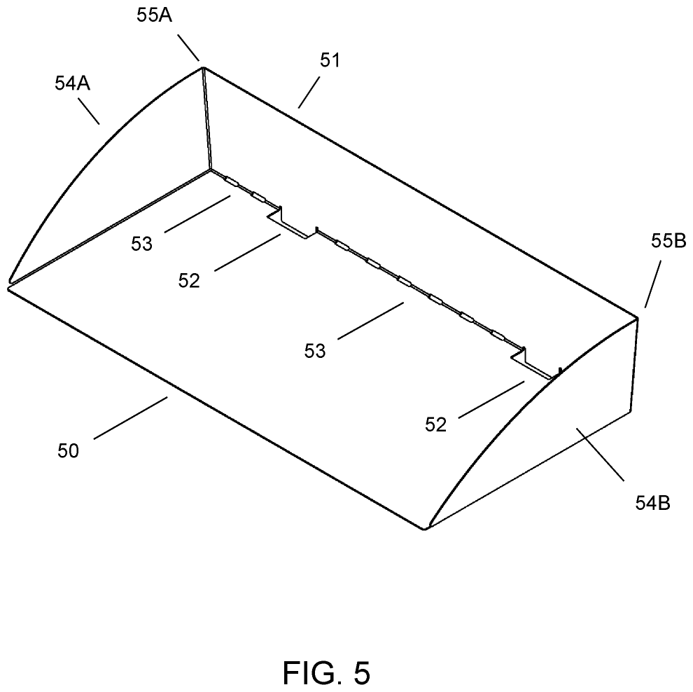

In a collapsible embodiment shown in FIG. 5, bottom panel 50 is coupled to rear panel 51 via hinged connections 53. Rear panel 51 comprises one or more rear engagement flaps 52, two of which are shown in FIG. 5. Left panel 54A is coupled to rear panel 51 via hinged connection 55A and is either uncoupled or releasably coupled (for example via a friction fit) to bottom panel 50. Right panel 54B is coupled to rear panel 51 via hinged connection 55B and is either uncoupled or releasably coupled (for example via a friction fit) to bottom panel 50. The hinged connections allow the panels to be folded so that the complete device effectively lays flat, allowing for compact storage when not in use.

In vertically adjustable embodiments, a rear wall of the device is formed by a panel or panels configured to extend and retract, allowing a user to adjust the vertical height of the rear wall. By adjusting the height of the rear wall, the user can select a suitable height to, for example, fit the device between the grill grates and an upper grill basket if there is one. In some embodiments, the vertical height can be made adjustable by sliding one panel vertically with respect to a fixed panel and secured in place. In some embodiments, a back wall comprises two or more panels folded over each other and which can be unfolded and secured in place to extend the height of the back wall. The vertical dimension of the rear wall is preferably configured so that the rear wall does not interfere with operation of the grill, such as the cover or a burner positioned in the grill's back wall.

In horizontally adjustable embodiments, one or more bottom panels of the device are configured to extend and retract, allowing a user to adjust the horizontal width of the bottom surface. In such embodiments, the device can be dimensioned horizontally to fit a portion of the grilling surface and preferably with slightly smaller dimensions than the grilling surface to allow for ease of installation and removal. In some embodiments, the device can also be fabricated with one or more sliding and locking mechanisms so that the device can be adapted to horizontally fit differently dimensioned grills. For example, a device may comprise a tooth and groove system with one or more release mechanisms, such as side mounted buttons, to disengage a sliding and locking mechanism and allow the device to reach a different horizontal width.

Although the embodiments described hereinabove relate to rectangularly shaped grills, the device can be formed in different shapes, such as semi-circular to fit round grills, or other appropriate shapes for differently or unconventionally dimensioned grills. In some embodiments, a semi-circular bottom panel is coupled to a rear panel along a curved rear edge. Optionally, the rear panel and bottom panel are detachable. In some such embodiments, the rear panel may be flexible when detached so that the rear panel can lay substantially flat atop the bottom panel for transport or storage.

In some embodiments, the device is formed unitarily as one piece that can easily be inserted and removed from the grill for cleaning and storage. In some embodiments, the device is fabricated from a metal that is rust resistant and can withstand the heat of the grill. For example, a very thin sheet of the same metal used to form the grill walls can be rolled and formed into a unitary device using known metal fabrication methods. In some embodiments, the device can be formed from lightweight heat resistant polymers and carbon based material, such as that used in commercially available grill mats, in a thickness sufficient to maintain rigidity. In some embodiments, the device can be made from aluminum, such as that used to fabricate aluminum roasting pans. In various embodiments, a device may be made from one or more of the following: a heat resistant metal, a plastic, a carbon based material, silicon, and aluminum. Disposable embodiments of the device can be sold in bulk and can eliminate cleaning if the user decides to dispose of the device after a single use. Lightweight materials can be used to make the device more portable. The gauge of the material used for the device is preferably rigid enough to enable stability yet still provide transportability. In some embodiments, a non-stick coating and/or a non-stick ceramic surface is used to provide easier movement of food onto, across, and off of the device during cooking and to provide easier cleaning of the device between uses. In some embodiments, a dimpled or other suitably textured surface may be used for the bottom panel and/or rear panel to provide desired control of food items along the surface.

In some embodiments, the device is formed from a single piece of aluminum or other suitable material that can be intended for single-use or designed for reusability after cleaning. In some embodiments, the rear engagement flap is foldable and provided in a first horizontal storage position that can be manually extended to a vertical position with simple hand motion.

Different dimensions may be selected according to the intended application of a device or the size or shape of a grill a device is to be used on. Generally, about 4 inches is a suitable height for a rear wall of a device, but can be more or less according to design considerations. Preferably, the rear wall of a device is 0.5 inch to 6 inches in height when configured for use on a residential grill. The bottom portion extends horizontally preferably towards the front of the grill a few inches from the back wall. Generally, a few inches, for example 3 to 6 inches, may be sufficient. Depending on the user's needs and preferences, a smaller or larger bottom length, such as 0.5 inch to 10 inches, may be suitable. In some embodiments, the flat portion may be extended a greater length toward the front of the grill such that it can also serve as a place for food items to rest for a longer period of time. Different dimensions may be selected as appropriate for commercial or industrial grills or non-standard residential grills.

Each of the foregoing embodiments contains one or more features that may be incorporated into other embodiments without departing from the principles disclosed herein. For example, an embodiment of a device may include a rear engagement flap, a beveled front edge, adjustable horizontal length, and a non-stick coating, without departing from the principles disclosed herein.

The detailed description is not intended to be limiting or represent an exhaustive enumeration of the principles disclosed herein. It will be apparent to those of skill in the art that numerous changes may be made in such details without departing from the spirit of the principles disclosed herein.

What is claimed is:

1. A device for use with a grilling apparatus, the device comprising:
a bottom panel comprising a tapered or beveled leading edge;
a rear panel coupled to the bottom panel;
the rear panel comprising a rear engagement flap configured to substantially engage a back wall of a grilling apparatus; and
wherein a bottom surface of the bottom panel is configured to rest upon a grill grate.

2. The device of claim 1, wherein a side horizontal dimension of the bottom panel is less than a side horizontal dimension of the grill grate, and a side horizontal dimension of the back panel is less than the side horizontal dimension of the grill grate.

3. The device of claim 2, wherein a forward horizontal dimension of the bottom panel is less than a forward horizontal dimension of the grill grate.

4. The device of claim 1, wherein the rear panel comprises a vertically downward collapsible portion along a bottom edge of the rear panel.

5. The device of claim 1, further comprising:
a left side wall and a right side wall, each coupled to the bottom panel and the rear panel, and each extending vertically the same or less than the vertical dimension of the rear panel and extending forwardly horizontally the same or less than the forward horizontal dimension of the bottom panel; and
wherein the left side wall is positioned at a first distal horizontal edge of the bottom panel and a first distal horizontal edge of the rear panel so as to engage the bottom panel and rear panel; and
wherein the right side wall is positioned at a second opposite distal horizontal edge of the bottom panel and a second opposite distal horizontal edge of the rear panel so as to engage the bottom panel and rear panel.

6. The device of claim 5, wherein the left side wall and the right side wall are each curved in an arc from a point of engagement with the rear panel to a point of engagement with the bottom panel.

7. The device of claim 6, wherein:
the left side wall comprises a left side collapsible portion configured to allow the left side wall to fold and collapse inwardly; and
the right side wall comprises a right side collapsible portion configured to allow the right side wall to fold and collapse inwardly.

8. The device of claim 7 wherein:
the rear panel and the bottom panel are engaged with an edge collapsible portion along a bottom edge of the rear panel and a back edge of the bottom panel;
the edge collapsible portion is configured to allow the rear panel to fold from a vertical position to a horizontal position; and
the left side panel and the right side panel are configured to collapse inwardly as the rear panel is being moved to a horizontal position.

9. The device of claim 8 wherein the edge collapsible portion comprises a hinge, a heat resistant bendable material, or a flexible thin metal strip.

10. The device of claim 1, wherein the bottom panel and the rear panel are formed unitarily as a single device from a heat resistant material.

11. The device of claim 1, wherein the device consists of one of the following: a heat resistant metal, a plastic, a carbon based material, silicon, and aluminum.

12. The device of claim 1, comprising at least one hole in the rear panel configured to enable the device to be secured to the grilling apparatus.

13. A device for use with a grilling apparatus, the device comprising:
a substantially curved rear panel;
a bottom panel comprising a tapered or beveled leading edge, the bottom panel substantially curved along a common edge where the bottom panel is coupled to the rear panel;
the rear panel comprising a rear engagement flap configured to substantially engage a wall of a grilling apparatus; and
wherein a bottom surface of the bottom panel is configured to rest upon a grill grate.

14. The device of claim 13, wherein a radius of the bottom panel is dimensioned less than a radius of the grill grate.

15. The device of claim 13, wherein the rear panel is detachable from the bottom panel.

16. The device of claim 15, wherein the rear panel is flexible and configured to lay substantially flat when detached from the bottom panel.

17. The device of claim 13, wherein the bottom panel and the rear panel are formed unitarily as a single device from a heat resistant material.

18. The device of claim 13, wherein the device consists of one of the following: a heat resistant metal, a plastic, a carbon based material, silicon, and aluminum.

19. The device of claim 13, comprising at least one hole in the rear panel configured to enable the device to be secured to the grilling apparatus.
